(19) United States
(12) Patent Application Publication
(10) Pub. No.: US 2019/0220045 A1
(43) Pub. Date: Jul. 18, 2019

(54) FAUCET

(71) Applicants: CHENG-FENG HUANG, CHANGHUA (TW); YU-LIN HUANG, CHANGHUA (TW)

(72) Inventors: CHENG-FENG HUANG, CHANGHUA (TW); YU-LIN HUANG, CHANGHUA (TW)

(73) Assignee: CHANG PENG METAL INDUSTRIAL CO., LTD., Changhua (TW)

(21) Appl. No.: 15/871,960

(22) Filed: Jan. 15, 2018

(51) Int. Cl. G05D 23/13

(52) U.S. Cl. CPC G05D 23/1313

(57) ABSTRACT

A faucet may comprise a main body, a ceramic control valve, a locating sleeve, a driving block, a handle, an adaptor, and a spout. The handle of the faucet in the present invention is positioned at a front side of the faucet, which is convenient for a user to operate the faucet and saves water during the process of operating the faucet.

### FIELD OF THE INVENTION

The present invention relates to a faucet and more particularly to a faucet easy for use.

### BACKGROUND OF THE INVENTION

A conventional faucet is generally installed on a kitchen counter around a sink and comprises at least two water channels which respectively connect to hot water source and cold water source. Moreover, the faucet has a spout and a ceramic control valve respectively formed at a top portion and an interior portion thereof. An end of the spout is connected to a faucet head, and the control valve having a driving valve piece and a fixed valve piece is connected to a control handle. Furthermore, the control handle is adapted to drive the driving valve piece to change relative positions between the driving valve piece and the fixed valve piece, thereby controlling on/off operation of the faucet, ratio of hot and cold water, and the amount of water flow.

However, the conventional faucet is disadvantageous because: the control valve only can be installed in the faucet at a side position, which makes the operation of the faucet more difficult and wastes more water during the process of operating the faucet. Therefore, there remains a need for a new and improved design for a faucet to overcome the problems presented above.

### SUMMARY OF THE INVENTION

The present invention provides a faucet which comprises a main body, a ceramic control valve, a locating sleeve, a driving block, a handle, an adaptor, and a spout. The main body has a chamber at an upper portion thereof, and two water inlet holes penetrating through a bottom portion of the chamber are configured to connect cold and hot water sources. Furthermore, an upper portion of an outer periphery of the main body has a first connecting section. The control valve has a valve shell, and a rotating base is installed therein. A lower portion of the rotating base is coupled with a driving valve piece, and a lower portion of the driving valve piece is coupled with a fixed valve piece, wherein the driving valve piece and the fixed valve piece are positioned in the valve shell. A center of a top portion of the rotating base comprises a valve tube upwardly sticking out of the valve shell. The rotating base is configured to engage with the driving valve piece, and through operating the valve tube, the rotating base driven by the valve tube is adapted to drive and have synchronous rotation with the driving valve piece so as to change the relative positions between the driving valve piece and the fixed valve piece and then to control on/off operation of the faucet, ratio of hot and cold water and the amount of water flow. A valve base is configured to couple with and block a bottom portion of the valve shell, thereby securing the fixed valve piece, the driving valve piece and the rotating base in the valve shell. Moreover, the fixed valve piece has a second through hole and a third through hole while the valve base comprises a fourth through hole and the fifth through hole, wherein the second through hole of the fixed valve piece is configured to align with the fourth through hole of the valve base for passing by cold water while the third through hole of the fixed valve piece is adapted to align with the fifth through hole of the valve base for passing by hot water. A mixing hole is located between the second through hole and the third through hole on the fixed valve piece. Additionally, the driving valve piece has a first through hole penetrating through a central portion thereof, and two lateral sides of the first through hole respectively connect to a first extending portion and a second extending portion. When the valve tube is not operated, each of the first extending portion and the second extending portion is fully misaligned with the second through hole and the third through hole of the fixed valve piece such that cold and hot water are blocked by the driving valve piece and not flow out from the valve tube of the control valve. The locating sleeve has an annular edge protruding from an inner periphery thereof, and a second connecting section is formed below the annular edge on the inner periphery of the locating sleeve. Moreover, an elongated opening is configured to horizontally penetrate through the locating sleeve at a position above the annular edge. The control valve is positioned into the chamber of the main body, and the fourth through hole and the fifth through hole are respectively communicated with the two water inlet holes. Thereafter, the second connecting section of the locating sleeve is configured to engage with the first connecting section of the main body to enable the locating sleeve to be located around an outer periphery of the valve tube of the control valve, and the elongated opening is adapted to be located at a middle position of a front side of the faucet. Furthermore, after the locating sleeve connected to the main body, the annular edge is configured to bear against and limit a position of the control valve. The driving block has a coupling hole axially penetrating through a central portion thereof. The driving block is configured to be downwardly positioned into the locating sleeve, and the coupling hole is adapted to cover around the outer periphery of the valve tube. In addition, a first connecting hole and a second connecting hole respectively penetrate through a lateral wall of the driving block, and a screw is configured to screw in the first connecting hole to bear against the valve tube. Moreover, an end of the handle is adapted to pass through the elongated opening of the locating sleeve to connect to the second connecting hole of the driving block. Through pulling the handle which is coupled with the elongated opening, the driving block driven by the handle is configured to drive the valve tube to have limited rotation. The adapter secured on a top portion of the locating sleeve is adapted to connect to the spout.

Comparing with conventional faucet, the present invention is advantageous because: the handle is positioned at a front side of the faucet, which is convenient for a user to operate the faucet and saves water during the process of operating the faucet.

### BRIEF DESCRIPTION OF THE DRAWINGS

FIG. 1 is a three-dimensional assembly view of a faucet of the present invention.

FIG. 2 is a three-dimensional exploded view of the faucet of the present invention.

FIG. 3 is a detailed exploded view of a ceramic control valve of the faucet of the present invention.

FIG. 4 is a plan view of a driving valve piece of the faucet of the present invention.

FIG. 5 is a plan view of a fixed valve piece of the faucet of the present invention.

FIG. 6 is a schematic view illustrating relative positions between the driving valve piece and the fixed valve piece when the faucet of the present invention is turned off.

FIG. 7 is a sectional assembly view of the faucet of the present invention.

FIG. 8 is a schematic view illustrating a handle is pulled to operate the faucet of the present invention.

FIG. 9 is a schematic view illustrating relative positions between the driving valve piece and the fixed valve piece when only cold water flows out from the faucet of the present invention.

FIG. 10 is a schematic view illustrating relative positions between the driving valve piece and the fixed valve piece when warm water mixed from cold and hot water flows out from the faucet of the present invention.

FIG. 11 is a schematic view illustrating relative positions between the driving valve piece and the fixed valve piece when only hot water flows out from the faucet of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

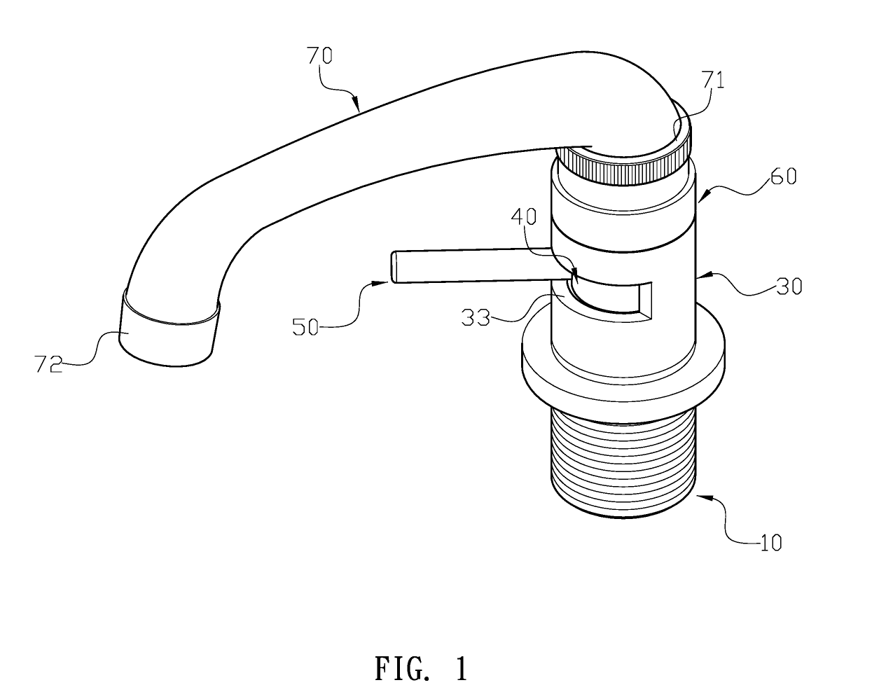

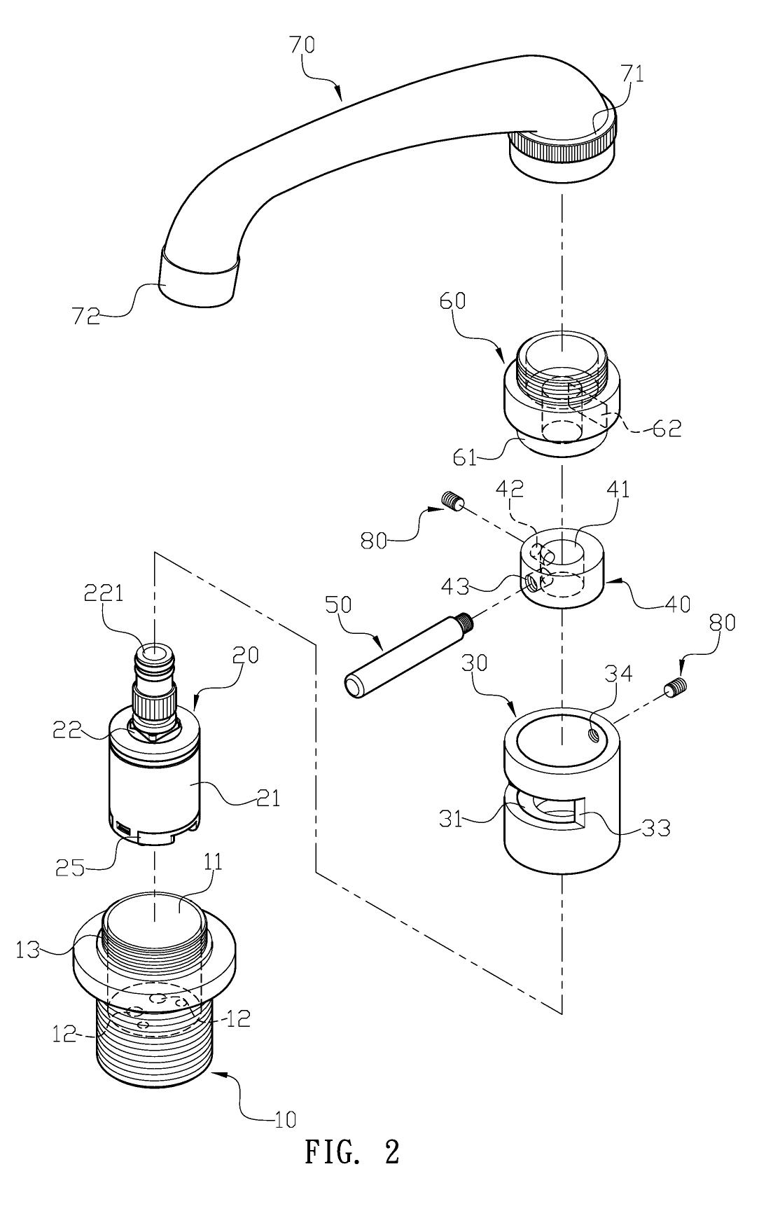

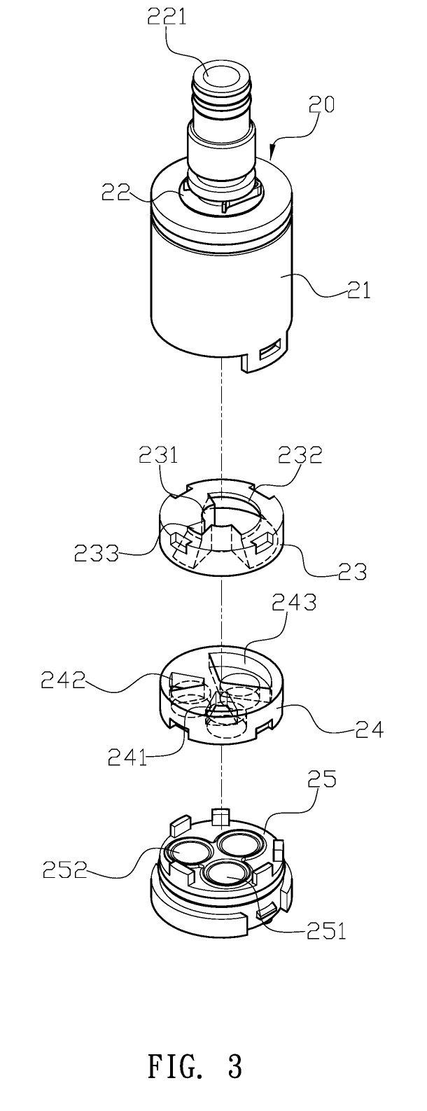

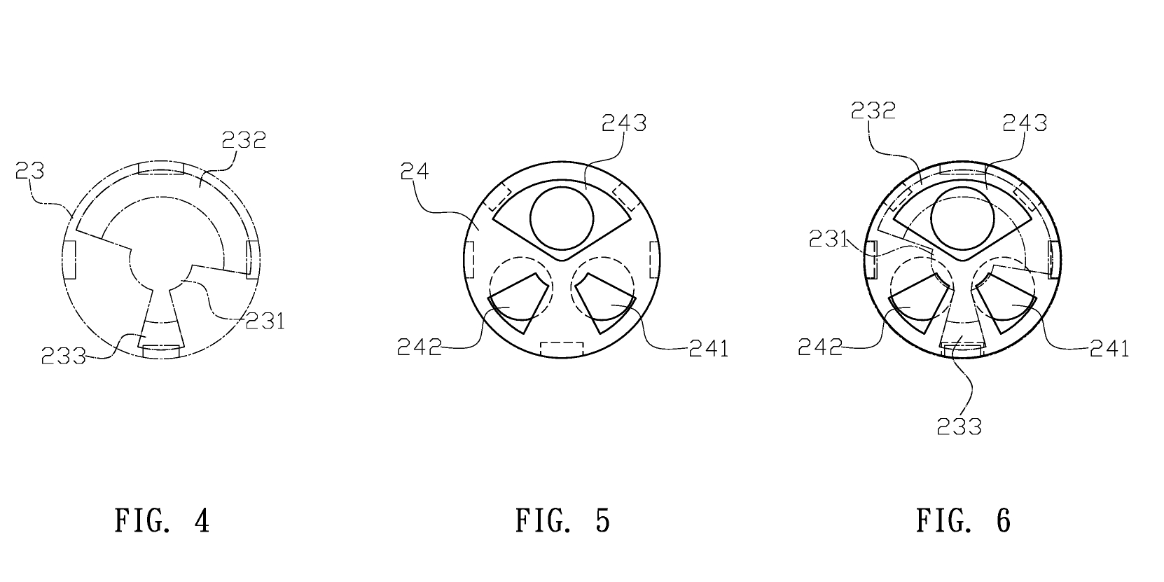

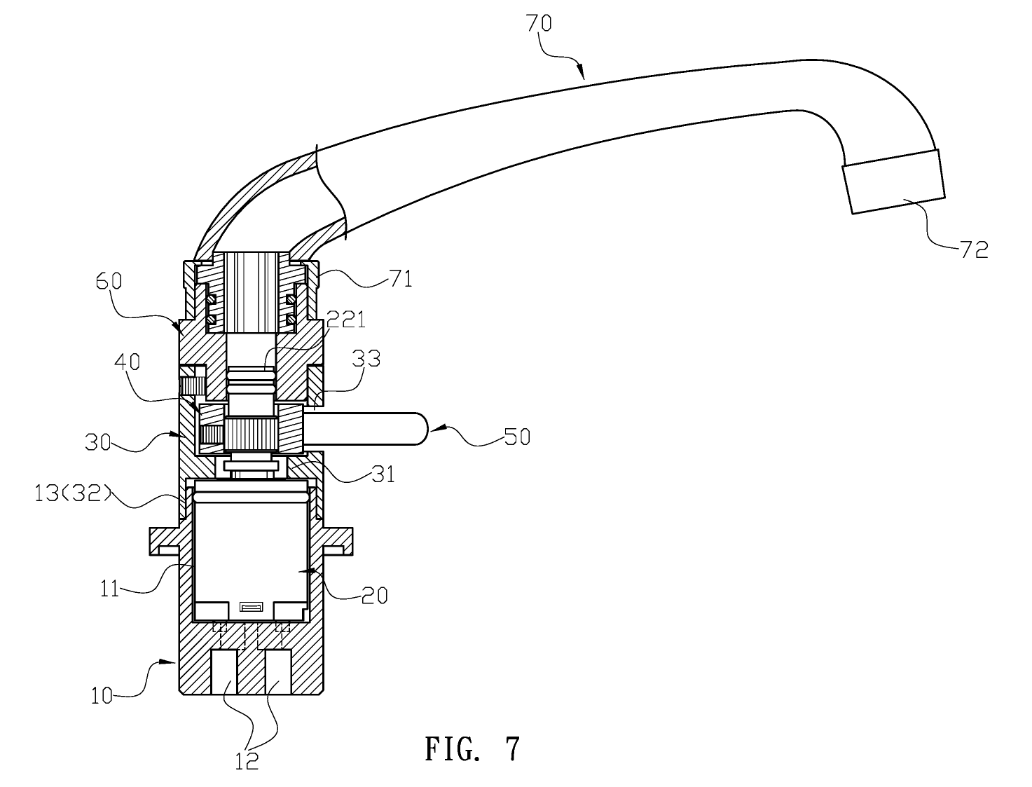

Referring to FIGS. 1 to 7, the present invention provides a faucet which comprises a main body (10), a ceramic control valve (20), a locating sleeve (30), a driving block (40), a handle (50), an adaptor (60), and a spout (70). The main body (10) has a chamber (11) at an upper portion thereof, and two water inlet holes (12) penetrating through a bottom portion of the chamber (11) are configured to connect cold and hot water sources. Furthermore, an upper portion of an outer periphery of the main body (10) has a first connecting section (13). The control valve (20) has a valve shell (21), and a rotating base (22) is installed therein. A lower portion of the rotating base (22) is coupled with a driving valve piece (23), and a lower portion of the driving valve piece (23) is coupled with a fixed valve piece (24), wherein the driving valve piece (23) and the fixed valve piece (24) are positioned in the valve shell (21). A center of a top portion of the rotating base (22) comprises a valve tube (221) upwardly sticking out of the valve shell (21). The rotating base (22) is configured to engage with the driving valve piece (23), and through operating the valve tube (221), the rotating base (22) driven by the valve tube (221) is adapted to drive and have synchronous rotation with the driving valve piece (23) so as to change the relative positions between the driving valve piece (23) and the fixed valve piece (24) and then to control on/off operation of the faucet, ratio of hot and cold water and the amount of water flow. A valve base (25) is configured to couple with and block a bottom portion of the valve shell (21), thereby securing the fixed valve piece (24), the driving valve piece (23) and the rotating base (22) in the valve shell (21). Moreover, the fixed valve piece (24) has a second through hole (241) and a third through hole (242) while the valve base (25) comprises a fourth through hole (251) and the fifth through hole (252), wherein the second through hole (241) of the fixed valve piece (24) is configured to align with the fourth through hole (251) of the valve base (25) for passing by cold water while the third through hole (242) of the fixed valve piece (24) is adapted to align with the fifth through hole (252) of the valve base (25) for passing by hot water. A mixing hole (243) is located between the second through hole (241) and the third through hole (242) on the fixed valve piece (24). Additionally, the driving valve piece (23) has a first through hole (231) penetrating through a central portion thereof, and two lateral sides of the first through hole (231) respectively connect to a first extending portion (232) and a second extending portion (233). When the valve tube (221) is not operated, each of the first extending portion (232) and the second extending portion (233) is fully misaligned with the second through hole (241) and the third through hole (242) of the fixed valve piece (24) such that cold and hot water are blocked by the driving valve piece (23) and not flow out from the valve tube (221) of the control valve (20). The locating sleeve (30) has an annular edge (31) protruding from an inner periphery thereof, and a second connecting section (32) is formed below the annular edge (31) on the inner periphery of the locating sleeve (30). Moreover, an elongated opening (33) is configured to horizontally penetrate through the locating sleeve (30) at a position above the annular edge (31). The control valve (20) is positioned into the chamber (11) of the main body (10), and the fourth through hole (251) and the fifth through hole (252) are respectively communicated with the two water inlet holes (12). Thereafter, the second connecting section (32) of the locating sleeve (30) is configured to engage with the first connecting section (13) of the main body (10) to enable the locating sleeve (30) to be located around an outer periphery of the valve tube (221) of the control valve (20), and the elongated opening (33) is adapted to be located at a middle position of a front side of the faucet. Furthermore, after the locating sleeve (30) connected to the main body (10), the annular edge (31) is configured to bear against and limit a position of the control valve (20). The driving block (40) has a coupling hole (41) axially penetrating through a central portion thereof. The driving block (40) is configured to be downwardly positioned into the locating sleeve (30), and the coupling hole (41) is adapted to cover around the outer periphery of the valve tube (221). In addition, a first connecting hole (42) and a second connecting hole (43) respectively penetrate through a lateral wall of the driving block (40), and a screw (80) is configured to screw in the first connecting hole (43) to bear against the valve tube (221). Moreover, an end of the handle (50) is adapted to pass through the elongated opening (33) of the locating sleeve (30) to connect to the second connecting hole (43) of the driving block (40). Through pulling the handle (50) which is coupled with the elongated opening (33), the driving block (40) driven by the handle (50) is configured to drive the valve tube (221) to have limited rotation. The adapter (60) secured on a top portion of the locating sleeve (30) is adapted to connect to the spout (70).

In one embodiment, the first connecting section (13) and the second connecting section (32) respectively have an outer threaded section and an inner threaded section thereon to engage together.

In another embodiment, each of the first extending portion (232) and the second extending portion (233) is a downward inclined surface extending from the first through hole (231).

In still another embodiment, each of the first extending portion (232) and the second extending portion (233) is formed in a fan shape, and the first extending portion (232) is larger than the second extending portion (233).

In a further embodiment, the mixing hole (243) is a recess on a top surface of the fixed valve piece (24).

In still a further embodiment, a coupling portion (61) protrudes from a bottom portion of the adapter (60), and the diameter of the coupling portion (61) is smaller than the adapter (60), and a lateral side of the coupling portion (61) comprises a cutting edge (62); a third connecting hole (34) horizontally penetrates through the upper portion of the locating sleeve (30), and the coupling portion (61) is configured to be positioned into the locating sleeve (30), and the screw (80) is adapted to screw into the third connecting hole (34) to bear against the cutting edge (62), thereby securing the adapter (60) on the top portion of the locating sleeve (30).

In a preferred embodiment, a first threaded section (71) is formed at one end of the spout (70) while a faucet head (72) is installed on the other end thereof; the spout (70) is connected to the adapter (60) through the first threaded section (71), which enables the spout (70) to be rotated about the adapter (60).

In an advantageous embodiment, the faucet head (72) is a faucet aerator.

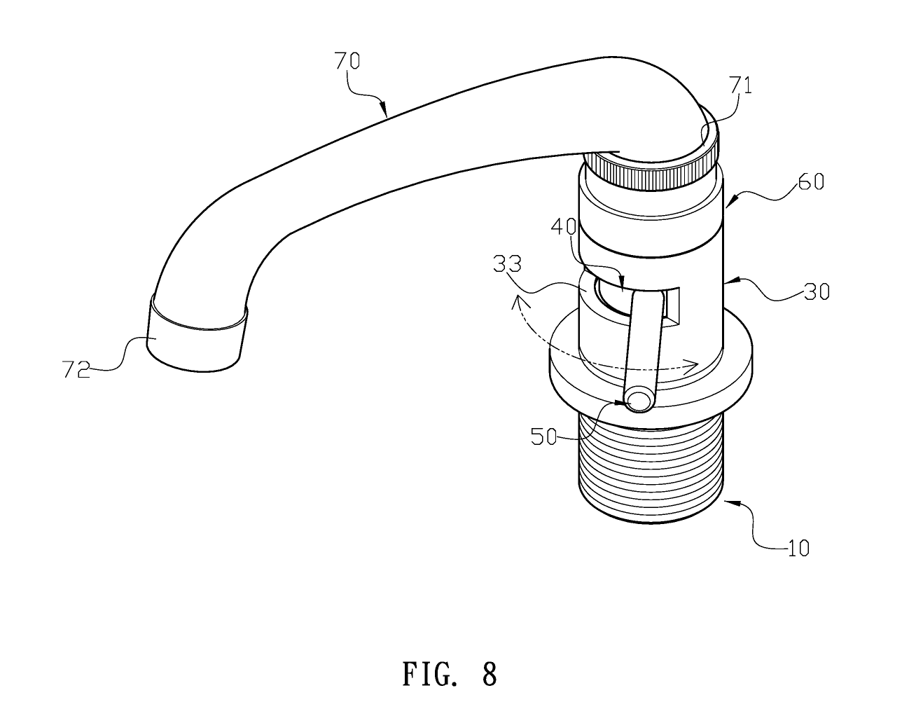

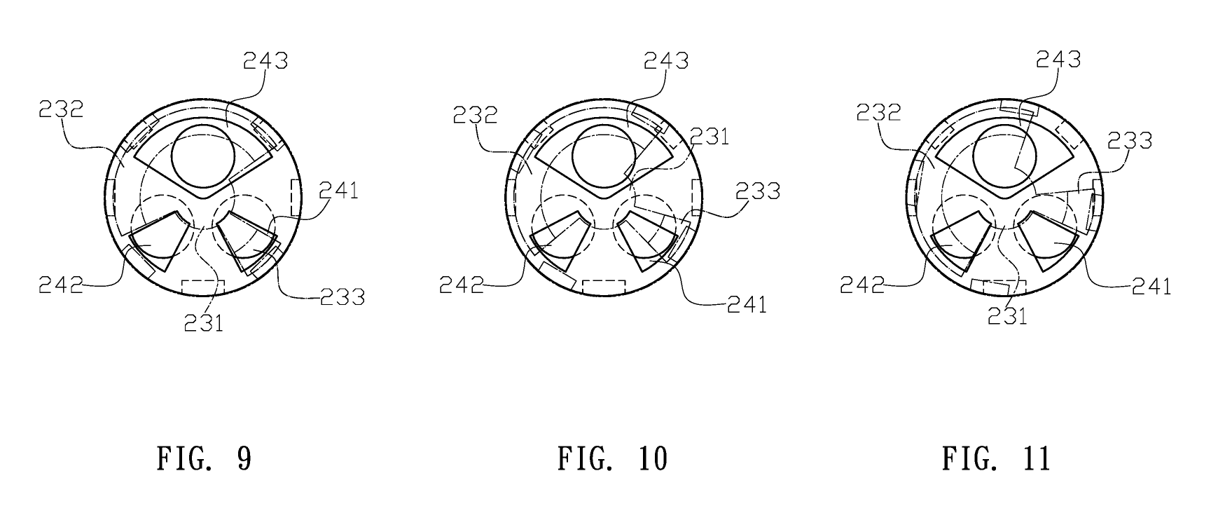

In actual application, the faucet of the present invention is installed on a table or a kitchen counter around a water sink, and through pulling the handle (50) (as shown in FIG. 8), the valve tube (221) is configured to drive the rotating base (22) and the driving valve piece (23) to have synchronous rotations. Through aligning the second extending portion (233) with the second through hole (241) (as shown in FIG. 9), cold water is adapted to flow from one of the water inlet hole (12) through the fourth through hole (251) and the second through hole (241) into the control valve (20), and then flows through the second extending portion (233), the first through hole (231), the valve tube (221) and out of the faucet from the spout (70). When warm water or hot water is needed, a user can continue to pull the handle (50) further away from an initial position, and the first extending portion (232) is configured to gradually overlap with the third through hole (242). When the first extending portion (232) and the second extending portion (233) are communicated with the third through hole (242), the second through hole (241) and mixing hole (243) simultaneously (as shown in FIG. 10), cold and hot water are configured to be mixed to form warm water flowing out of the faucet. When the handle (50) travels farthest to reach the other end of the initial position, the second extending portion (233) is adapted to totally misalign with the second through hole (241) and the first extending portion (232) is configured to entirely cover the third through hole (242) (as shown in FIG. 11), thereby enabling the faucet to discharge only hot water. Also, the user can pull the handle (50) back to its initial position to turn off the faucet.

Comparing with conventional faucet, the present invention is advantageous because: the handle (50) is positioned at a front side of the faucet, which is convenient for a user to operate the faucet and saves water during the process of operating the faucet.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A faucet comprising a main body, a ceramic control valve, a locating sleeve, a driving block, a handle, an adaptor, and a spout;
wherein the main body has a chamber at an upper portion thereof, and two water inlet holes penetrating through a bottom portion of the chamber are configured to connect cold and hot water sources, and an upper portion of an outer periphery of the main body has a first connecting section;
wherein the control valve has a valve shell, and a rotating base is installed therein; a lower portion of the rotating base is coupled with a driving valve piece, and a lower portion of the driving valve piece is coupled with a fixed valve piece, wherein the driving valve piece and the fixed valve piece are positioned in the valve shell; a center of a top portion of the rotating base comprises a valve tube upwardly sticking out of the valve shell; the rotating base is configured to engage with the driving valve piece, and through operating the valve tube, the rotating base driven by the valve tube is adapted to drive and have synchronous rotation with the driving valve piece so as to change the relative positions between the driving valve piece and the fixed valve piece and thereby to control on/off operation of the faucet, ratio of hot and cold water and the amount of water flow; a valve base is configured to couple with and block a bottom portion of the valve shell, thereby securing the fixed valve piece, the driving valve piece and the rotating base in the valve shell; the fixed valve piece has a second through hole and a third through hole while the valve base comprises a fourth through hole and the fifth through hole, wherein the second through hole of the fixed valve piece is configured to align with the fourth through hole of the valve base for passing by cold water while the third through hole of the fixed valve piece is adapted to align with the fifth through hole of the valve base for passing by hot water; a mixing hole is located between the second through hole and the third through hole on the fixed valve piece; the driving valve piece has a first through hole penetrating through a central portion thereof, and two lateral sides of the first through hole respectively connect to a first extending portion and a second extending portion; when the valve tube is not operated, each of the first extending portion and the second extending portion is completely misaligned with the second through hole and the third through hole of the fixed valve piece such that cold and hot water are blocked by the driving valve piece and not flow out from the valve tube of the control valve;
wherein the locating sleeve has an annular edge protruding from an inner periphery thereof, and a second connecting section is formed below the annular edge on the inner periphery of the locating sleeve; an elongated opening is configured to horizontally penetrate through the locating sleeve at a position above the annular edge; the control valve is positioned into the chamber of the main body, and the fourth through hole and the fifth through hole are respectively communicated with the two water inlet holes, and the second connecting section of the locating sleeve is configured to engage with the first connecting section of the main body to enable the locating sleeve to be located around an outer periphery of the valve tube of the control valve, and the elongated opening is adapted to be located at a middle position of a front side of the faucet; after the locating sleeve connected to the main body, the annular edge is configured to bear against and limit a position of the control valve;
wherein the driving block, which has a coupling hole axially penetrating through a central portion thereof, is configured to be downwardly positioned into the locating sleeve, and the coupling hole is adapted to cover around the outer periphery of the valve tube; a first connecting hole and a second connecting hole respectively penetrate through a lateral wall of the driving block, and a screw is configured to screw in the first connecting hole to bear against the valve tube;
wherein an end of the handle is adapted to pass through the elongated opening of the locating sleeve to connect to the second connecting hole of the driving block, and through pulling the handle which has maximum shift limited by the elongated opening, the driving block driven by the handle is configured to drive the valve tube to have limited rotation; and
wherein the adapter secured on a top portion of the locating sleeve is adapted to connect to the spout.

2. The faucet of claim 1, wherein the first connecting section and the second connecting section respectively have an outer threaded section and an inner threaded section thereon to engage together.

3. The faucet of claim 1, wherein each of the first extending portion and the second extending portion is a downward inclined surface extending from the first through hole.

4. The faucet of claim 1, wherein each of the first extending portion and the second extending portion is formed in a fan shape, and the first extending portion is larger than the second extending portion.

5. The faucet of claim 1, wherein the mixing hole is a recess on a top surface of the fixed valve piece.

6. The faucet of claim 1, wherein a coupling portion protrudes from a bottom portion of the adapter, and the diameter of the coupling portion is smaller than the adapter, and a lateral side of the coupling portion comprises a cutting edge; a third connecting hole horizontally penetrates through the upper portion of the locating sleeve, and the coupling portion is configured to be positioned into the locating sleeve, and a screw is adapted to screw in the third connecting hole to bear against the cutting edge, thereby securing the adapter on the top portion of the locating sleeve.

7. The faucet of claim 1, wherein a first threaded section is formed at one end of the spout while a faucet head is installed on the other end thereof; the spout is connected to the adapter through the first threaded section, which enables the spout to be rotated about the adapter.

8. The faucet of claim 7, wherein the faucet head is a faucet aerator.
